(19) United States
(12) Patent Application Publication
(10) Pub. No.: US 2021/0246253 A1
(43) Pub. Date: Aug. 12, 2021

(54) METHOD AND APPARATUS FOR PRODUCING A POLYURETHANE DISPERSION HAVING REDUCED FOAM FORMATION

(71) Applicant: Covestro Intellectual Property GmbH & Co. KG, Leverkusen (DE)

(72) Inventors: Sebastian Doerr, Düsseldorf (DE); Martin Brahm, Odenthal (DE); Alfred Zastrow, Dormagen (DE); Volker Michele, Köln (DE)

(21) Appl. No.: 16/972,146

(22) PCT Filed: Jul. 1, 2019
(86) PCT No.: PCT/EP2019/067509

§ 371 Date: Dec. 4, 2020

(30) Foreign Application Priority Data
Jul. 3, 2018 (EP) 18181433.6

(51) Int. Cl. C08G 18/08; C08G 18/75; C08G 18/12

(52) U.S. Cl. CPC C08G 18/0866; C08G 18/12; C08G 18/755

(57) ABSTRACT

The invention relates to a method for producing a polyurethane dispersion, comprising the steps: I) providing polyurethane polymers and/or polyurethane prepolymers A) in a liquid phase comprising a first solvent, which solvent is miscible with water and has a lower boiling point than water; II) in the event that isocyanate functional polymers or isocyanate functional prepolymers were provided in step I): adding NCO-reactive compounds such that, at least in part, a reaction with the polymers or prepolymers occurs; III) distilling off the first solvent, which is miscible with water, such than an aqueous polyurethane dispersion is obtained; wherein the liquid phase in step I) still comprises water and/or after step II), water is added to the mixture obtained according to step II). Foam bubbles created during step III) are contacted at least temporarily by a second solvent. The first and second solvents are preferably acetone. The invention further relates to an apparatus for carrying out the method according to the invention.

The present invention relates to a process for producing a polyurethane dispersion, comprising the steps of:
I) providing polyurethane polymers and/or polyurethane prepolymers A) in a liquid phase comprising a first solvent which is miscible with water and has a lower boiling point than water;
II) if isocyanate-functional polymers or isocyanate-functional prepolymers have been provided in step I): adding NCO-reactive compounds, such that at least partial reaction with the polymers or prepolymers occurs;
III) distilling off the water-miscible first solvent, such that an aqueous polyurethane dispersion is obtained;
   where the liquid phase in step I) still comprises water and/or, after step II), water is added to the mixture obtained after step II).

The invention likewise relates to an apparatus for performance of the process of the invention.

In the production of low-solvent polyurethane dispersions, the polymer is at first present dissolved in acetone and is then dispersed in water. Subsequently, the acetone is removed by distillation under reduced pressure. Large amounts of foam often arise here, which means that the distillation rate has to be distinctly reduced. This lowers the space-time yield of the plant. The addition of defoamers, the chemical basis of which is frequently hydrophobic mineral oils or silicone oils, can only partly suppress foam formation. Furthermore, the presence of defoamers is undesirable in many products. For example, defoamers can result in leveling defects in paints.

DE 27 08 442 A1 relates to a process for producing modified aqueous polymer dispersions, wherein room temperature liquid organic diisocyanates are introduced into non-sedimented, aqueous polymer dispersions containing polyurethanes, optionally in the simultaneous presence of catalysts that accelerate isocyanate polyaddition reactions and/or dimerization of isocyanate groups and/or carbodiimidization of isocyanate groups and/or trimerization of isocyanate groups, while mixing at such a temperature where there is no visible foam formation, the temperature conditions mentioned are maintained on completion of addition of the diisocyanate until at least 50% of isocyanate groups of the diisocyanate introduced have reacted and the conversion is optionally subsequently conducted to completion by heating to temperatures up to 100° C.

It is an object of the present invention to provide a process and an apparatus for production of a polyurethane dispersion, in which lower foam formation occurs during the distillative removal of organic solvents.

This object is achieved by a process as claimed in claim 1 and an apparatus as claimed in claim 14. Advantageous developments are specified in the dependent claims. They may be freely combined unless the opposite is clear from the context.

A process for producing a polyurethane dispersion comprises the steps of:
I) providing polyurethane polymers and/or polyurethane prepolymers A) in a liquid phase comprising a first solvent which is miscible with water and has a lower boiling point than water;
II) if isocyanate-functional polymers or isocyanate-functional prepolymers have been provided in step I): adding NCO-reactive compounds, such that at least partial reaction with the polymers or prepolymers occurs;
III) distilling off the water-miscible first solvent, such that an aqueous polyurethane dispersion is obtained;
   where the liquid phase in step I) still comprises water and/or, after step II), water is added to the mixture obtained after step II).

Foam bubbles formed during step III) are at least temporarily contacted with a second solvent.

It has been found that, surprisingly, the second solvent introduced during the distillation in step III) effectively destroys the foam bubbles. Without being tied to a theory, it is assumed that significant fluctuation in the interfacial tension takes place locally, which destabilizes the foam lamellae and hence leads to bursting of the bubbles. This allows distinctly more rapid distillation.

The polymer or prepolymer A) may have an average NCO functionality of 0 to 6, preferably of ≥1.8 to ≤3.5. For preparation thereof, the polyisocyanate is or the polyisocyanates are used in stoichiometric excess/deficiency, such that the polymer or prepolymer has terminal isocyanate groups or OH groups.

Particularly suitable solvents for the prepolymer are wholly or partly miscible with water in the temperature range of 10° C.-120° C., are unreactive toward isocyanate groups and may optionally be distilled off after production of the dispersion. It is additionally also possible, in addition to the aforementioned solvents, to use further water-immiscible or sparingly water-miscible solvents that are not reactive toward isocyanate groups. Also suitable for production of the dispersions of the invention are solvent mixtures of multiple solvents that meet the aforementioned conditions.

Preferred solvents are acetone, butanone, tetrahydrofuran, ethyl acetate, butyl acetate and/or dimethyl carbonate. Very particular preference is given to acetone.

In one embodiment, the isocyanate-functional prepolymers A) are obtainable from the reaction of

A1) organic polyisocyanates with

A2) monomeric polyols and/or polymeric polyols having number-average molecular weights of ≥400 g/mol to ≤8000 g/mol and OH functionalities of ≥1.5 to ≤6.

Suitable polyisocyanates A1) are aromatic, araliphatic, aliphatic or cycloaliphatic polyisocyanates. It is also possible to use mixtures of such polyisocyanates. Preferred polyisocyanates are selected from the group consisting of butylene diisocyanate, hexamethylene diisocyanate (HDI), pentamethylene 1,5-diisocyanate, isophorone diisocyanate (IPDI), 2,2,4- and/or 2,4,4-trimethylhexamethylene diisocyanate, the isomeric bis(4,4′-isocyanatocyclohexyl)methanes or mixtures thereof with any isomer content, isocyanatomethyloctane 1,8-diisocyanate, cyclohexylene 1,4-diisocyanate, phenylene 1,4-diisocyanate, tolylene 2,4- and/or 2,6-diisocyanate, naphthylene 1,5-diisocyanate, diphenylmethane 2,4′- or 4,4′-diisocyanate, triphenylmethane 4,4′,4″-triisocyanate and derivatives thereof having urethane, isocyanurate, allophanate, biuret, uretdione, iminooxadiazinedione structure. Also preferred are mixtures thereof. Particular preference is given to hexamethylene diisocyanate, isophorone diisocyanate, pentamethylene diisocyanate and the isomeric bis(4,4′-isocyanatocyclohexyl)methanes, and mixtures thereof.

Suitable monomeric polyols A2) are, for example, short-chain aliphatic, araliphatic or cycloaliphatic polyols, i.e. those containing 2 to 20 carbon atoms. Examples of diols are ethylene glycol, diethylene glycol, triethylene glycol, tetraethylene glycol, dipropylene glycol, tripropylene glycol, propane-1,2-diol, propane-1,3-diol, butane-1,4-diol, neopentyl glycol, 2-ethyl-2-butylpropanediol, trimethylpentanediol, positionally isomeric diethyloctanediols, 1,3-butylene glycol, cyclohexanediol, cyclohexane-1,4-dimethanol, hexane-1,6-diol, cyclohexane-1,2- and -1,4-diol, hydrogenated bisphenol A (2,2-bis(4-hydroxycyclohexyl)propane), 2,2-dimethyl-3-hydroxypropyl 2,2-dimethyl-3-hydroxypropionate. Preference is given to butane-1,4-diol, cyclohexane-1,4-dimethanol and hexane-1,6-diol. Examples of suitable triols are trimethylolethane, trimethylolpropane or glycerol, preference being given to trimethylolpropane.

The polymeric polyols A2) are compounds formed in turn from monomers and, in addition to the usually terminal isocyanate-reactive end groups, having further functional groups along the main chain.

Suitable higher molecular weight polyols are polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols and polyester polycarbonate polyols, polyether polyamines and polyamido polyamines; particular preference is given to polyester polyols, polyether polyols and polycarbonate polyols; particular preference is given to polyester polyols.

The suitable polyester polyols are frequently formed from one or more aliphatic and/or aromatic and/or araliphatic dicarboxylic acids with one or more aliphatic and/or aromatic and/or araliphatic diols and are prepared via a polycondensation process.

Polyester polyols of good suitability are the known polycondensates of di- and optionally tri- and tetraols and di- and optionally tri- and tetracarboxylic acids or hydroxycarboxylic acids or lactones. Instead of the free polycarboxylic acids, it is also possible to use the corresponding polycarboxylic anhydrides or corresponding polycarboxylic esters of lower alcohols for preparing the polyesters. Examples of suitable diols are ethylene glycol, butylene glycol, diethylene glycol, triethylene glycol, polyalkylene glycols such as polyethylene glycol, and also propane-1,2-diol, propane-1,3-diol, butane-1,3-diol, butane-1,4-diol, hexane-1,6-diol and isomers, neopentyl glycol or neopentyl glycol hydroxypivalate, preference being given to the three latter compounds. In order to achieve a functionality ≥2, it is possible to use proportions of polyols having a functionality of 3, examples of which include trimethylolpropane, glycerol, erythritol, pentaerythritol, trimethylolbenzene or trishydroxyethyl isocyanurate.

Preferred dicarboxylic acids are phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, succinic acid, 3,3-diethylglutaric acid, 2,2-dimethylsuccinic acid. Anhydrides of these acids are likewise usable, where they exist. For the purposes of the present invention, the anhydrides are consequently covered by the expression “acid”. Preference is also given to using monocarboxylic acids such as benzoic acid and hexanecarboxylic acid, provided that the mean functionality of the polyol is ≥2. Saturated aliphatic or aromatic acids are preferred, such as adipic acid or isophthalic acid. One example of a polycarboxylic acid for optional additional use in smaller amounts here is trimellitic acid.

Examples of hydroxycarboxylic acids suitable as co-reactants in the preparation of a polyester polyol having terminal hydroxyl groups include hydroxycaproic acid, hydroxybutyric acid, hydroxydecanoic acid, hydroxystearic acid and the like. Usable lactones include ε-caprolactone, butyrolactone and homologs.

Preference is given to polyester polyols based on butanediol and/or neopentyl glycol and/or hexanediol and/or ethylene glycol and/or diethylene glycol with adipic acid and/or phthalic acid and/or isophthalic acid. Particular preference is given to polyester polyols based on butanediol and/or neopentyl glycol and/or hexanediol with adipic acid and/or phthalic acid.

Polyether polyols include, for example, the polyaddition products of the styrene oxides, of ethylene oxide, propylene oxide, tetrahydrofuran, butylene oxide, epichlorohydrin, and the mixed addition and grafting products thereof, and the polyether polyols obtained by condensation of polyhydric alcohols or mixtures thereof and those obtained by alkoxylation of polyhydric alcohols, amines and amino alcohols.

Suitable hydroxy-functional polyethers have OH functionalities of 1.5 to 6.0, preferably 1.8 to 3.0, OH numbers of 50 to 700 and preferably of 100 to 600 mg KOH/g of solids, and molecular weights Mn of 106 to 4000 g/mol, preferably of 200 to 3500, for example alkoxylation products of hydroxy-functional starter molecules such as ethylene glycol, propylene glycol, butanediol, hexanediol, trimethylolpropane, glycerol, pentaerythritol, sorbitol or mixtures of these and also other hydroxy-functional compounds with propylene oxide or butylene oxide. Preference is given to polypropylene oxide polyols and polytetramethylene oxide polyols having a molecular weight of 300 to 4000 g/mol. In this context, the polyether polyols of particularly low molecular weight, given correspondingly high OH contents, may be water-soluble. Particular preference is given however to water-insoluble polypropylene oxide polyols and polytetramethylene oxide polyols having a molecular weight of 500-3000 g/mol and mixtures thereof.

The useful polycarbonate polyols are obtainable by reaction of carbonic acid derivatives, for example diphenyl carbonate, dimethyl carbonate or phosgene, with diols. Useful diols of this kind include, for example, ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, bisphenol A, tetrabromobisphenol A, but also lactone-modified diols. Preferably, the diol component contains 40% to 100% by weight of hexane-1,6-diol and/or hexanediol derivatives, preferably those having not only terminal OH groups but also ether or ester groups, for example products which are obtained by reaction of 1 mol of hexanediol with at least 1 mol, preferably 1 to 2 mol, of ε-caprolactone, or by etherification of hexanediol with itself to give di- or trihexylene glycol. It is also possible to use polyether polycarbonate polyols.

Preference is given to polycarbonate polyols based on dimethyl carbonate and hexanediol and/or butanediol and/or ε-caprolactone. Very particular preference is given to polycarbonate polyols based on dimethyl carbonate and hexanediol and/or ε-caprolactone.

It is also possible that, in the synthesis of the prepolymers, isocyanate-reactive cationic, potentially cationic, anionic or potentially anionic and/or nonionic hydrophilizing agents A4) are added directly. Details of the hydrophilizing agents A4) are given further down in the text.

In a further preferred embodiment, in step II), isocyanate-reactive compounds A3) having molecular weights of 62 to 399 g/mol are added. The degree of chain extension, i.e. the equivalents ratio of NCO-reactive groups of the compounds used for chain extension and chain termination to free NCO groups of the prepolymer, is generally between 40% and 150%, preferably between 50% and 110%, more preferably between 60% and 100%.

Chain extension of the prepolymers with compounds A3) can be accomplished, for example, using amines having no ionic or ionogenic groups, such as anionically hydrophilizing groups. Preference is given to using, as component A3), organic di- or polyamines such as for example ethylene-1,2-diamine, 1,2- and 1,3-diaminopropane, 1,4-diaminobutane, 1,6-diaminohexane, isophoronediamine, an isomer mixture of 2,2,4- and 2,4,4-trimethylhexamethylenediamine, 2-methylpentamethylenediamine, diethylenetriamine, 4,4-diaminodicyclohexylmethane, hydrazine hydrate and/or dimethylethylenediamine.

In addition, components A3) used may also be compounds that have not only a primary amino group but also secondary amino groups, or not only an amino group (primary or secondary) but also OH groups. Examples thereof are primary/secondary amines such as diethanolamine, 3-amino-1-methylaminopropane, 3-amino-1-ethylaminopropane, 3-amino-1-cyclohexylaminopropane, 3-amino-1-methylaminobutane, alkanolamines such as N-aminoethylethanolamine, ethanolamine, 3-aminopropanol, neopentanolamine.

Furthermore, components A3) used may also be monofunctional isocyanate-reactive amine compounds, for example methylamine, ethylamine, propylamine, butylamine, octylamine, laurylamine, stearylamine, isononyloxypropylamine, dimethylamine, diethylamine, dipropylamine, dibutylamine, N-methylaminopropylamine, diethyl(methyl)aminopropylamine, morpholine, piperidine, or suitable substituted derivatives thereof, amide amines formed from diprimary amines and monocarboxylic acids, monoketime of diprimary amines, primary/tertiary amines, such as N,N-dimethylaminopropylamine.

Suitable components A3) are also dihydrazides, for example adipic dihydrazide, oxalic dihydrazide, carbohydrazide, and succinic dihydrazide. Likewise useful as component A3) are longer-chain amino-functional compounds such as polyetheramines (“Jeffamines”).

Components A3) used are preferably ethylene-1,2-diamine, bis(4-aminocyclohexyl)methane, 1,4-diaminobutane, isophoronediamine, ethanolamine, diethanolamine and diethylenetriamine.

Chain extension of the prepolymers with compounds A3) can also be accomplished using low molecular weight polyols, for example. Suitable low molecular weight polyols are short-chain aliphatic, araliphatic or cycloaliphatic compounds, i.e. those containing 2 to 20 carbon atoms.

Examples of diols are ethylene glycol, diethylene glycol, triethylene glycol, tetraethylene glycol, dipropylene glycol, tripropylene glycol, propane-1,2-diol, propane-1,3-diol, butane-1,4-diol, neopentyl glycol, 2-ethyl-2-butylpropanediol, trimethylpentanediol, positionally isomeric diethyloctanediols, 1,3-butylene glycol, cyclohexanediol, cyclohexane-1,4-dimethanol, hexane-1,6-diol, cyclohexane-1,2- and -1,4-diol, hydrogenated bisphenol A (2,2-bis(4-hydroxycyclohexyl)propane), 2,2-dimethyl-3-hydroxypropyl 2,2-dimethyl-3-hydroxypropionate. Preference is given to butane-1,4-diol, cyclohexane-1,4-dimethanol and hexane-1,6-diol. Examples of suitable triols are trimethylolethane, trimethylolpropane or glycerol, preference being given to trimethylolpropane.

Further examples of chain extenders A3) are dihydrazides such as oxalic dihydrazide, carbohydrazide and adipic dihydrazide, particular preference being given to carbohydrazide and adipic dihydrazide. Examples of suitable dithiols are ethane-1,2-dithiol, propane-1,3-dithiol, butane-1,4-dithiol and hexane-1,6-dithiol. Particular preference is given to ethane-1,2-dithiol and hexane-1,6-dithiol.

Low molecular weight compounds A3) used are preferably diols.

In a further embodiment, step II) isocyanate-reactive cationic, potentially cationic, anionic or potentially anionic and/or nonionic hydrophilizing agents A4) are added. The degree of chain extension, i.e. the equivalents ratio of NCO-reactive groups of the compounds used for chain extension and chain termination to free NCO groups of the prepolymer, is generally between 40% and 150%, preferably between 50% and 110%, more preferably between 60% and 100%.

Dispersing compounds (hydrophilizing agents) A4) are those that contain, for example, sulfonium, ammonium, phosphonium, carboxylate, sulfonate or phosphonate groups or groups which can be converted by salt formation to the aforementioned groups (potentially ionic groups), or polyether groups, and can be incorporated into the macromolecules via isocyanate-reactive groups present. The neutralizing agents required for salt formation may be added either stoichiometrically or in deficiency relative to the salt-forming group. Anionic groups are generated by adding organic bases, such as tertiary amines, or inorganic bases, such as alkali metal hydroxides or ammonia. Preference is given here to using tertiary amines such as triethylamine, triethanolamine or dimethylethanolamine Preferred suitable isocyanate-reactive groups are hydroxyl and amino groups.

Suitable ionic or potentially ionic compounds are, for example, mono- and dihydroxycarboxylic acids, mono- and diaminocarboxylic acids, mono- and dihydroxysulfonic acids, mono- and diaminosulfonic acids and mono- and dihydroxyphosphonic acids or mono- and diaminophosphonic acids and salts thereof, such as dimethylolpropionic acid, dimethylolbutyric acid, hydroxypivalic acid, N-(2-aminoethyl)alanine, 2-(2-aminoethylamino)ethanesulfonic acid, ethylenediaminepropyl- or -butylsulfonic acid, propylene-1,2- or -1,3-diamineethylsulfonic acid, malic acid, citric acid, glycolic acid, lactic acid, glycine, alanine, taurine, lysine, 3,5-diaminobenzoic acid, an addition product of IPDI and acrylic acid (EP-A 0 916 647, example 1) and the alkali metal and/or ammonium salts thereof; the adduct of sodium bisulfite onto but-2-ene-1,4-diol, polyethersulfonate, the propoxylated adduct of 2-butenediol and NaHSO₃, described, for example, in DE-A 2 446 440 (pages 5-9, formulae and units that can be converted to cationic groups, such as N-methyldiethanolamine, as hydrophilic formation components. Furthermore, the salt of cyclohexaminopropanesulfonic acid (CAPS) from WO-A 01/88006 can be used as an anionic hydrophilizing agent. Preferred ionic or potential ionic compounds are those having carboxyl or carboxylate and/or sulfonate groups and/or ammonium groups.

Preferred compounds are polyether sulfonate, dimethylolpropionic acid, tartaric acid and dimethylolbutyric acid, particular preference being given to polyether sulfonate and dimethylolpropionic acid.

Suitable nonionically hydrophilizing compounds are, for example, polyoxyalkylene ethers containing at least one hydroxyl or amino group. These polyethers contain a proportion of 30% by weight to 100% by weight of units derived from ethylene oxide. Useful compounds include polyethers of linear construction having a functionality between 1 and 3, but also compounds of the general formula:

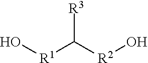

in which R1 and R2 are each independently a divalent aliphatic, cycloaliphatic or aromatic radical which has 1 to 18 carbon atoms and may be interrupted by oxygen and/or nitrogen atoms, and R3 is an alkoxy-terminated polyethylene oxide radical.

Nonionic hydrophilizing compounds are, for example, also monovalent polyalkylene oxide polyether alcohols having a statistical average of 5 to 70, preferably 7 to 55, ethylene oxide units per molecule, as obtainable in a manner known per se by alkoxylation of suitable starter molecules.

Suitable starter molecules are, for example, saturated monoalcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methylcyclohexanols or hydroxymethylcyclohexane, 3-ethyl-3-hydroxymethyloxetane or tetrahydrofurfuryl alcohol, diethylene glycol monoalkyl ethers, for example diethylene glycol monobutyl ether, unsaturated alcohols such as allyl alcohol, 1,1-dimethylallyl alcohol or olein alcohol, aromatic alcohols such as phenol, the isomeric cresols or methoxyphenols, araliphatic alcohols such as benzyl alcohol, anisyl alcohol or cinnamyl alcohol, secondary monoamines such as dimethylamine, diethylamine, dipropylamine, diisopropylamine, dibutylamine, bis(2-ethylhexyl)amine, N-methyl- and N-ethylcyclohexylamine or dicyclohexylamine, and heterocyclic secondary amines such as morpholine, pyrrolidine, piperidine or 1H-pyrazole. Preferred starter molecules are saturated monoalcohols. Particular preference is given to using diethylene glycol monobutyl ether as starter molecule.

Alkylene oxides suitable for the alkoxylation reaction are especially ethylene oxide and propylene oxide, which can be used in the alkoxylation reaction in any sequence or else in a mixture.

The polyalkylene oxide polyether alcohols are either pure polyethylene oxide polyethers or mixed polyalkylene oxide polyethers whose alkylene oxide units consist to an extent of at least 30 mol %, preferably to an extent of at least 40 mol %, of ethylene oxide units. Preferred nonionic compounds are monofunctional mixed polyalkylene oxide polyethers having at least 40 mol % of ethylene oxide units and not more than 60 mol % of propylene oxide units.

Particular preference is given to monohydroxy-functional alkoxypolyethylene glycols such as MPEG 750 (Dow Chemical) and LB 25 (Covestro) and dihydroxy-functional compounds having lateral polyethylene oxide units such as Ymer N 120 (Perstorp) or Tegomer D 3404.

A particularly preferred prepolymer is prepared from a polyester formed from adipic acid, hexane-1,6-diol and neopentyl glycol, and hexamethylene diisocyanate. The polyester preferably has a molar mass of 1700 g/mol.

A particularly preferred chain extension reagent is 2-(2-aminoethylamino)ethanesulfonic acid.

The molar ratio for the preparation of the prepolymer A) of NCO groups to isocyanate-reactive groups may vary here from 1.05-4.00, preferably from 1.2-3.0, more preferably from 1.4-2.5. The prepolymers are prepared by initially charging a reaction vessel with the appropriate polyol or a mixture of different polyols and subsequently adding the polyisocyanate or the mixture of polyisocyanates at elevated temperature. If mixtures of polyols and/or polyisocyanates are used, the individual co-reactants may then also be added at different junctures in order to achieve controlled formation of the prepolymer. The reaction here can be effected either in the melt or else in suitable, inert solvents, for example acetone or butanone. The reaction temperature here is between 50° C. and 130° C. and the reaction time is 1 h-24 h. The urethanization reaction may be accelerated by using suitable catalysts. Suitable for this purpose are the catalysts known to those skilled in the art such as triethylamine, 1,4-diazabicyclo-[2.2.2]-octane, tin dioctoate, dibutyltin dilaurate or bismuth dioctoate, which are initially charged or metered in at a later stage. Preference is given to dibutyltin dilaurate. The reaction has typically ended when there is no further change in the NCO content; the reaction is typically monitored by titration. In order to ensure the further processing of the prepolymer, low-viscosity prepolymers are generally advantageous, for which purpose, if not done during the preparation, the prepolymer is dissolved in a suitable solvent. Low-viscosity prepolymers or prepolymer solutions refer to those systems having viscosity of <104 mPas at a shear rate of 40 s-1. The prepolymer solution in this case preferably has a solids content of >40% and acetone is preferably used as solvent.

A preferred polyurethane dispersion to be prepared by the process of the invention contains 9% to 60% by weight of a polyisocyanate compound, 35% to 90% by weight of an isocyanate-reactive polyol having a molar mass of >500 g/mol, 0.5% to 5% by weight of an ionic or potentially ionic hydrophilizing agent, 0 to 10% by weight of low molecular weight (C₂ to C₈) alcohols and 0.5% to 10% by weight of a chain extender amine having no hydrophilic groups.

In a particularly preferred embodiment, the polyurethane dispersion contains at least one additive selected from the group consisting of 0.1% to 25.0% by weight of a nonionic hydrophilizing agent, 0.1 to 15.0% by weight of a further polyol having a molar mass of <500 g/mol, and 0.1% to 3.0% by weight of further auxiliaries or additives, especially emulsifiers, biocides, aging stabilizers.

In a further preferred embodiment, the process is performed in such a way that defoamers are present in the resultant polyurethane dispersion in a proportion of ≤1% by weight, based on the weight of the polyurethane. The content is preferably 0% by weight to ≤0.1% by weight, more preferably 0% by weight to ≤0.01% by weight. Most preferably, no defoamers are present in the dispersion obtained, this expression including technically unavoidable impurities. The defoamers may, for example, be silicone oils or paraffins.

In a further preferred embodiment, the second solvent is identical to the first solvent. For example, it is possible to condense solvent that has been distilled off and then contact it with foam bubbles again as the second solvent. This procedure has the further advantage that no changes in product properties are to be expected since, ultimately, no new substance is being introduced into the product.

In a further preferred embodiment, the first and second solvents are acetone.

In a further preferred embodiment, the foam bubbles are contacted with the second solvent by spraying from one or more spray nozzles. The spray nozzle or spray nozzles are preferably arranged so as to result in uniform coverage of the vessel cross section with the spray droplets of the second solvent.

In a further preferred embodiment, the one or more spray nozzles are disposed in the vapor space within a vessel used for distillation.

In a further preferred embodiment, in the distillative removal in step III), the vapor obtained is drawn off via at least one vapor tube and the foam bubbles are contacted with the second solvent in the vapor tube and/or at a distance of ≤1 m from the vapor tube. In this way, it is possible to further reduce the amount of second solvent required. In this embodiment, preference is given to contacting in the vicinity of (at a distance of less than one meter from) the vapor tube.

In general, the second solvent is preferably injected using one-phase nozzles that are not reliant on the addition of atomizing gas for the atomization. The bore diameter of the nozzles should be matched to the desired pressure drop; this should also take account of the tendency of small bores to become blocked by possible solid deposits.

When used in the vapor tube, it is possible to use commercially available full-cone or hollow-cone nozzles that are arranged coaxially in concurrent or (preferably) in countercurrent to the gas stream. The spray angle chosen in the nozzles should preferably be small (preferably 30° or less) in order to lose a minimum amount of liquid to the wall of the vapor tube. The bore diameter of the nozzles should be chosen so as to result in a pressure drop of the nozzles for the desired solvent stream of between 0.5 and 20 bar, preferably 1 to 10 bar and more preferably 1 to 3 bar.

When used in the vapor space of the distillation tank above the liquid level, it is preferably possible to use commercial flat jet nozzles that are arranged in such a way that the flat jet spreads horizontally over the liquid level and hence can cover a large area of the foam-filled gas space. Preference is given to flat-jet nozzles having large spray angles above 90°, more preferably above 120°. According to the geometry of the distillation apparatus, it is also possible to distribute multiple nozzles in the headspace in order to assure uniform coverage of the foam with spray. The bore diameter of the nozzles is preferably chosen so as to result in a pressure drop of the nozzles for the desired solvent stream of between 0.5 and 20 bar, preferably 1 to 10 bar and more preferably 1 to 3 bar. The vertical position of the nozzles between liquid level and vapor tube connection is preferably chosen such that, on the one hand, not too much spray is lost to the liquid level through the effect of gravity and, on the other hand, not too much spray is discharged with the vapor stream; preference is given to a position at half height between liquid level and vapor tube connection at the start of the distillation.

According to product properties, it may also be sufficient in the case of use in the vapor space of the distillation tank above the liquid level to mount just a single commercial flat jet nozzle immediately beneath the vapor tube; with regard to spray angle, bore diameter and pressure drop and vertical positioning of the nozzle, the same then applies as stated above.

The ideal droplet size may be different according to the mode of dispersion and influences the contact with the foam to be destroyed on the one hand and the entrainment in the vapor stream. The droplets preferably have a size of <2000 μm and more preferably <200 μm. Droplet sizes of <10 μm are less advantageous because they are transported away to a greater degree in the vapor stream. The droplet size can be influenced in an approximate manner via the choice of nozzle bore diameter and pressure drop in the spraying operation.

Depending on the temperature of the atomized solvent, there may be flash evaporation in the spraying operation; this is generally not preferred because it can give rise to very small droplets that are entrained with the vapor gas stream and do not lead to complete coverage of the foam-filled space with spray since they are very rapidly slowed down by the surrounding gas owing to their low inertia and the low falling speed.

In a further preferred embodiment, the second solvent is applied to the foam bubbles during step III) at a rate of ≥0.1% by volume/h to ≤20% (preferably ≤5%) by volume/h, based on the volume of the dispersion present during step III).

In a further preferred embodiment, the second solvent is used in an amount of ≤100%, preferably ≤30% and more preferably ≤10% of the amount of solvent present before step III).

During step III), the amount of the second solvent applied per unit time may be constant. In a further preferred embodiment, however, the amount of the second solvent applied during step III) is variable over time. The amount of the solvent applied is preferably reduced over the course of the process. It is additionally possible to apply the second solvent in a pulsed manner.

It is additionally preferable for the contacting with the second solvent to be effected only until the foam bubbles reach a predetermined layer height. This can be monitored with a foam probe.

In a further preferred embodiment, the contacting of the foam bubbles with the second solvent is performed exclusively within a pressure range from ≥80 mPa to ≤500 mPa. This has advantages in explosion protection of the plant.

A further aspect of the invention is an apparatus for performing the process of the invention, comprising a vessel to which a vacuum can be applied and which is set up to accommodate a polyurethane dispersion that develops foam bubbles on application of a vacuum. The apparatus further includes one or more nozzles through which a solvent can be applied to the foam bubbles.

In one embodiment of the apparatus, it is set up to condense solvent that has been distilled off and reapply it to the foam bubbles.

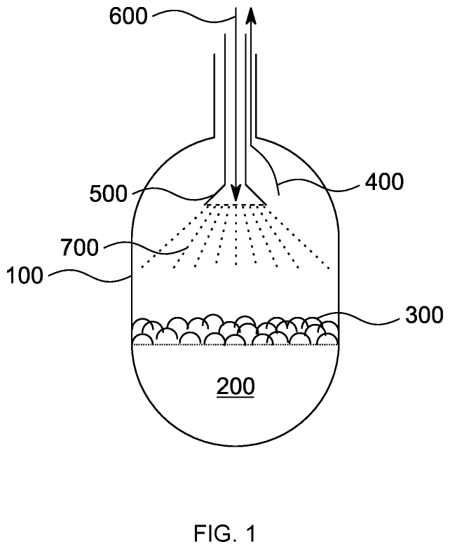

The present invention is elucidated in detail by the example that follows and FIG. 1, but without being limited thereto.

FIG. 1 shows an apparatus for performance of the process of the invention. This may be an appropriately modified distillation tank. The vessel 100 contains the aqueous polyurethane dispersion 200, out of which the organic solvent, for example acetone, is to be distilled. On application of a vacuum and optionally heating the dispersion 200, gaseous solvent can be drawn off at the top of the vessel 100. This is represented by stream of matter 400. In addition, foam bubbles 300 are formed on application of the vacuum.

In the vapor space, the apparatus has a nozzle 500 from which a stream 600 of a second solvent can be applied to the foam bubbles 300 in the form of individual jets or droplets 700. This results in bursting of the foam bubbles, and there is no risk of material from the dispersion 200 being entrained overhead in the apparatus.

The stream of matter 400 can be condensed and then can enter the nozzle 500 again in the form of stream of matter 600 and be applied to the foam bubbles 300.

Inventive Example: Preparation of a Polyurethaneurea Dispersion with a High Tendency to Foam

In a 500 L reactor with distillation unit, 56 kg of a polyester formed from adipic acid, hexanediol and neopentyl glycol and having an average molecular weight of 1700 g/mol and 5.5 kg of a hydrophilic monofunctional polyether based on ethylene oxide/propylene oxide (number-average molecular weight 2250 g/mol, OH number 25 mg KOH/g) were heated up to 65° C. Subsequently, 13.6 kg of isophorone diisocyanate (IPDI) was added and the mixture was stirred at 120° C. until the NCO value had gone below the theoretical value of 3.0%.

The resultant prepolymer was dissolved by adding 134 kg of acetone under pressure and simultaneously cooled down to 40° C. Subsequently, a solution of 3.2 kg of isophoronediamine (IPDA) in 24 kg of water was metered in at 40° C. The mixture was stirred for a further 15 min.

This was followed by dispersion by addition of 162 kg of water within 10 minutes. Directly thereafter, the crude dispersion was cautiously evacuated. At a pressure of 300 mbar (temperature: 34° C.), vigorous evolution of foam commenced, which made further distillation impossible.

It was only by the inventive spraying of the foam surface in the reactor by means of acetone from a flat-jet nozzle present above the liquid level (supply pressure: 3 bar, spray angle: 120°, flow rate calibrated with water: 15 kg/h, droplet size: about 200 μm) that it was possible to instantaneously break down the foam.

It was possible to efficiently continue the distillative removal of the acetone still present in the reaction mixture at this juncture by further cautious reduction of the pressure and slight raising of the internal reactor temperature. Briefly ending the inventive spraying of acetone after a distillation time of 5 hours by way of experiment led directly back to significant foam formation up to well into the vapor tube.

Therefore, the inventive spraying with acetone was restarted, which again resulted in suppression of foam formation. Even when the acetone supply pressure to the nozzle was lowered to 1.8 bar, the destruction of foam remained effective. 30 minutes before the distillation was ended, the spraying with acetone was stopped. The distillation was ended at a pressure of 150 mbar and an internal reactor temperature of 49° C. The total duration of the distillation ran to 7 hours.

A stable dispersion was obtained; the residual acetone content of the dispersion was 0.8% by weight.

1. A process for producing a polyurethane dispersion, comprising:
I) providing polyurethane polymers and/or polyurethane prepolymers A) in a liquid phase comprising a water-miscible first solvent having a lower boiling point than water;
II) if isocyanate-functional polymers or isocyanate-functional prepolymers are provided in step I): adding NCO-reactive compounds to form a mixture, such that at least partial reaction with the polyurethane polymers and/or polyurethane prepolymers A) occurs; and
III) distilling off the water-miscible first solvent to obtain an aqueous polyurethane dispersion, wherein foam bubbles formed during step III) are at least temporarily contacted with a second solvent,
wherein the liquid phase in step I) comprises water and/or, after step II), water is added to the mixture.

2. The process as claimed in claim 1, wherein the polyurethane prepolymers A) are obtained from the reaction of
A1) organic polyisocyanates with
A2) monomeric polyols and/or polymeric polyols having number-average molecular weights of ≥400 g/mol to ≤8000 g/mol and OH functionalities of ≥1.5 to ≤6.

3. The process as claimed in claim 1, wherein isocyanate-reactive compounds A3) having molecular weights of 62 to 399 g/mol are added in step II).

4. The process as claimed in claim 1, comprising adding hydrophilizing agents A4) in step II), wherein the hydrophilizing agents A4) comprise cationic or potentially cationic hydrophilizing agents, anionic or potentially anionic hydrophilizing agents, nonionic hydrophilizing agents, or a combination thereof.

5. The process as claimed in claim 1, wherein the polyurethane dispersion comprises a defoamer in an amount of ≤1% by weight, based on a total weight of the polyurethane.

6. The process as claimed in claim 1, wherein the second solvent is identical to the first solvent.

7. The process as claimed in claim 1, wherein the first and second solvents are acetone.

8. The process as claimed in claim 1, comprising spraying the second solvent from one or more spray nozzles to contact the foam bubbles.

9. The process as claimed in claim 8, wherein the one or more spray nozzles are disposed in a vapor space within a vessel used for distillation.

10. The process as claimed in claim 1, comprising drawing off vapor obtained in step III) via at least one vapor tube and contacting the foam bubbles with the second solvent in the vapor tube and/or at a distance of 1 m from the vapor tube.

11. The process as claimed in claim 1, comprising applying the second solvent to the foam bubbles during step III) at a rate of ≥0.1% by volume/h to ≤20% by volume/h, based on a total volume of the dispersion present during step III).

12. The process as claimed in any of claim 1, wherein contacting the foam bubbles with the second solvent is performed exclusively within a pressure range from ≥80 mPa to ≤500 mPa.

13. The process as claimed in claim 1, wherein an amount of the second solvent applied during step III) is variable over time.

14. An apparatus for performing the process as claimed in claim 1, comprising a vessel to which a vacuum can be applied and which is set up to accommodate a polyurethane dispersion that develops foam bubbles on application of a vacuum,
and including one or more nozzles through which a solvent can be applied to the foam bubbles.

15. The apparatus as claimed in claim 14, wherein the apparatus is set up to condense solvent that is distilled off and to reapply it to the foam bubbles.
